(19) United States
(12) Patent Application Publication
(10) Pub. No.: US 2008/0185281 A1
(43) Pub. Date: Aug. 7, 2008

(54) Touch input device

(75) Inventors: Ching-Sung Chang, Taipei (TW); David Ho, Taipei (TW); Po-Cheng Chen, Taipei (TW); Sea-Weng Young, Taipei (TW)

Correspondence Address: BIRCH STEWART KOLASCH & BIRCH, PO BOX 747, FALLS CHURCH, VA, 22040-0747, US

(73) Assignee: Inventec Appliances Corp.

(21) Appl. No.: 11/808,405

(22) Filed: Jun. 8, 2007

(30) Foreign Application Priority Data
Feb. 6, 2007 (TW) 96202286

(51) Int. Cl. H01H 9/26; H01H 1/10

(52) U.S. Cl. 200/5 A; 200/512

(57) ABSTRACT

A touch input device constructed in a carrier electronic apparatus comprises a touch panel, a flexible printed circuit board, a rubber cushion and a plurality of metal domes. The touch panel performs as a touch input interface of the apparatus to a user, the flexible printed circuit board is shaped into a C form so as to present an upper flexible printed circuit board and a lower flexible printed circuit board, the rubber cushion is disposed between the upper flexible printed circuit board and the lower flexible printed circuit board, and the plurality of metal domes is disposed between the rubber cushion and the lower flexible printed circuit board. Each of the metal domes is in a position to account for a specific function key.

### FIELD OF THE INVENTION

The invention relates to a touch input device, and more particularly to the touch input device that provides plural metal domes and that can alter the forcing pattern by introducing structural change.

### BACKGROUND OF THE INVENTION

Applications of directional push button devices or unidirectional touch pad devices are widely used in computers, personal digital assistants, and index input devices of electronic apparatuses. In the art, formulations of the push button devices are various and already well-known to the related skilled persons. FIG.1 demonstrates one of those varieties.

As illustrated, the push button device mainly includes a button unit 10, a film 12 made of thermoplastic polyurethane pellets (TPU), a flexible printed circuit board (FPCB) 14, a metal grid 16, and a rubber keypad interface 18. The button unit 10 including plural pop-up buttons is exposed to the housing of carrier apparatus. The TPU film 12 is introduced to prevent the button unit 10 from directly contacting the FPCB 14. The FPCB 14 provides a transducer 140 for forwarding electrically a touch signal upon the button unit 10 to a processing unit of the carrier apparatus. The metal grid 16 and the rubber keypad interface 18 are there to ensure the assembly of the push button device. In addition, the rubber keypad interface 18 can prevent the FPCB 14 from over deflection while in meeting extraordinary force upon the button unit 10.

No matter whether the touch pad is a resistant type, an electromagnetic type, or an inductance type, it mainly provides the touch panel and the FPCB to receive a control touch signal that can be realized further as indication of a 2D (2-dimension) moving control of the user.

Generally speaking, the touch pad is substantially a planar structure. In finger-inputting operation through the planar touch pad, less reaction sensibility against the action finger usually causes caution-less problems, such as multiple clicks, overtime depressions, or too-short-to-be-sensed touches. Definitely, either of the aforesaid problems results in operation errors or inconvenient usage.

Therefore, a push button type of the touch pad that could provide precise touch response without sacrificing user comforts for user is definitely popular among the skilled person in the art.

### SUMMARY OF THE INVENTION

Accordingly, it is an object of the present invention to provide a touch input device that introduces structural changes to alter forcing pattern thereupon and thereby to enhance the applicability of the touch input device.

The touch input device constructed in a portable electronic apparatus comprises a touch panel, a flexible printed circuit board, a rubber cushion and a plurality of metal domes. The touch panel performs as a touch input interface of the apparatus for a user, the flexible printed circuit board is folded into a C-shape form to present an upper flexible printed circuit board and a lower flexible printed circuit board, the rubber cushion is disposed between the upper flexible printed circuit board and the lower flexible printed circuit board, and the plural metal domes are disposed between the rubber cushion and the lower flexible printed circuit board. Each of the metal domes is in a position to account for a specific function key. By providing the rubber cushion, the flexibility of the touch input device can be enhanced and possible over-deflection upon the flexible printed circuit board can be successfully avoided while the user presses the function key.

### BRIEF DESCRIPTION OF THE DRAWINGS

The features, objects, and advantages of the present invention will become more apparent from the following detailed description of the preferred embodiment of this invention, with reference to the accompanying drawings, in which:

FIG. 1 is an exploded view of a conventional directional push button device;

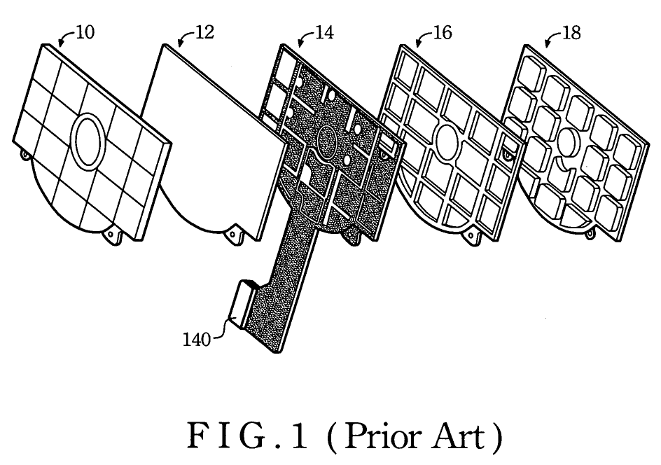

FIG. 2A is a front view and a top view of a preferred touch input device in accordance with the present invention;

FIG. 2B is a front view and a top view of the flexible printed circuit board (FPCB) of FIG. 2A; and

FIG. 3 illustrates schematically an application of the touch input device of the present invention.

### DETAILED DESCRIPTIONS OF THE PREFERRED EMBODIMENT

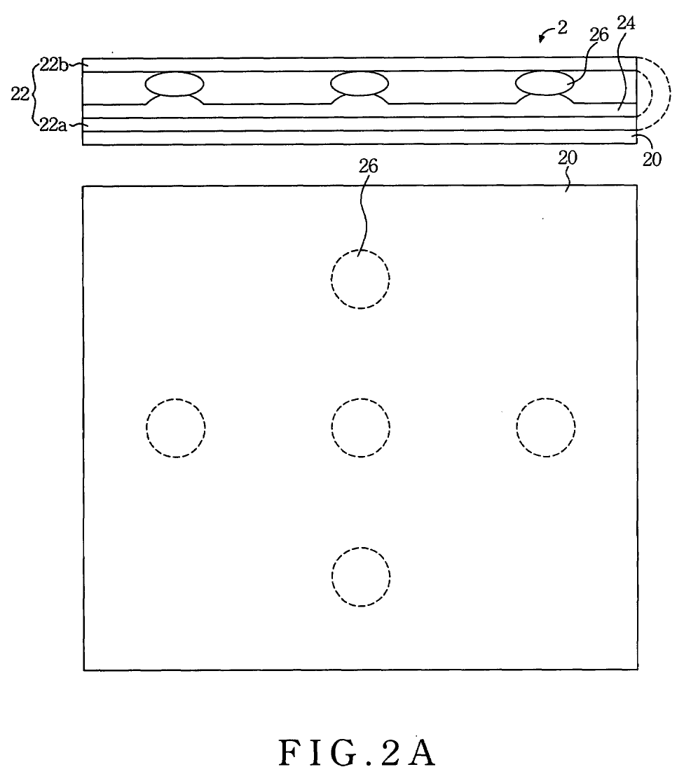

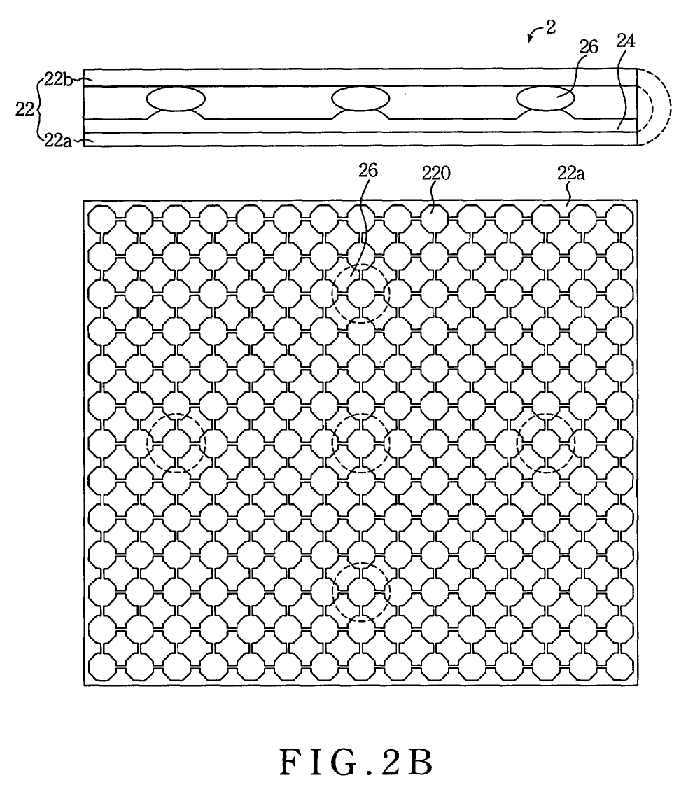

The invention disclosed herein is directed to a touch input device. In the following description, numerous details are set forth in order to provide a thorough understanding of the present invention. It will be appreciated by one skilled in the art that variations of these specific details are possible while still achieving the results of the present invention. In addition, well-known components are not described in detail in order not to unnecessarily obscure the present invention. Referring now to both FIG. 2A and FIG. 2B, a preferred touch input device of the present invention and a flexible printed circuit board (FPCB) of the touch input device are shown, respectively.

The touch input device is mounted inside an electronic apparatus that can be a mobile phone, a personal digital assistant, an MP3 player, an input device of a notebook computer, or any the like. In the present invention, the touch input device can be a capacitor type, an electromagnetic type, or a resistance type. Details to distinguish these three types are well known to the skilled person in the art and thus omitted herein.

The touch input device 2 comprises a touch panel 20, a flexible printed circuit board 22, a rubber cushion 24 and a plurality of metal domes 26. The touch panel 20 is an input interface between the touch input device and users. The touch panel 20 is made of a thermoplastic material, a transparent material, or a semi-transparent material, such as the thermoplastic polyurethane pellet (TPU).

The flexible printed circuit board 22 is disposed under the touch panel 20 and is folded into a C-shape form to present an upper flexible printed circuit board 22a and a lower flexible printed circuit board 22b. The upper surface of the upper flexible printed circuit board 22a has a plurality of sensor units 220 facing the touch panel 20. The plural sensor units 220 are used to detect the touch position of the user and further to coordinate movement of a cursor in the screen of the electronic apparatus.

The rubber cushion 24 is disposed between the upper flexible printed circuit board 22a and the lower flexible printed circuit board 22b, and sticks to the upper flexible printed circuit board 22a. The rubber cushion 24 is used to prevent excessive deformation of the flexible printed circuit board 22. The plural metal domes 26 are disposed in predetermined positions between the rubber cushion 24 and the lower flexible printed circuit board 22b. The position of each metal dome 26 is represented the position of a function key.

The plural metal domes 26 can be stuck on the rubber cushion 24. In the present invention, according to proper circuit designs, the metal domes 26 can be located directly, or in a predetermined spacing from the lower flexible printed circuit board 22b. The metal domes 26 can provide precise touch response without sacrificing user comfort, and can have the flexible printed circuit board 22 transmit the command of the function keys so as to carry out respective functions. In the present invention, sizes and number of the metal domes 26 depend on practical design requirements.

In the case that a user touches the touch panel 20 by his/her finger or a photo pen, the flexible printed circuit board 22 would generate a voltage signal in response to the user touch, and further to produce corresponding cursor signals and controls to move a cursor shown on a display of the portable electronic apparatus. By providing the rubber cushion 24 sandwiched between the upper and the lower flexible printed circuit boards 22a and 22b, the flexibility of the touch input device can be enhanced, and the possible over-deflection upon the flexible printed circuit board 22 that would cause operation errors of surrounding sensor units can be successfully avoided while the user presses the function key.

The flexible printed circuit board 22 can determine, by judging the action duration, if the user touch is to perform a click function or a button-depression function. In the case that the action duration is over 25 ms, the force is over a predetermined magnitude, or the force is not detected by any of the other sensor units 220 in 25 ms, the user touch is deemed as a button-depression application on the incident metal dome 26. Then, the function corresponding the incident metal dome 26 is performed and the touch panel 20 is temporarily disabled. On the other hand, in the case that the action duration is not over 25 ms, the force is not over a predetermined magnitude, or the force is detected by any of the other sensor units 220 in 25 ms, the user touch is deemed as a click application on the incident metal dome 26. In practice, in the case that a button-depression application and a click application are simultaneously detected, the button-depression application is the first to be performed.

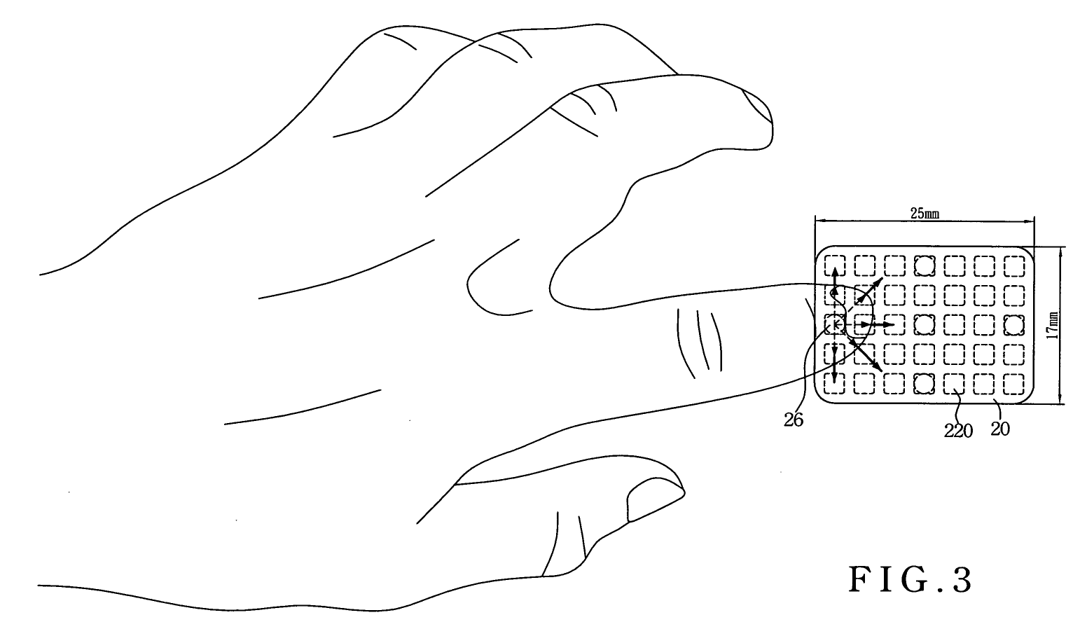

Please refer the FIG. 3, which shows schematically an application of the touch input device. According to the principles described above, the touch input device would judge the action duration if the user touch is to perform a click function or a button-depression function.

The touch area usually covers several sensor units 220 while the user finger touches on the touch panel 20, as shown in FIG. 3. When the user presses the left function key 26, the press (touch) area covers both the left function key 26 and the surrounding sensor units 220 which are crossed by the dotted arrows. Generally speaking, the touch input device detects user touch signals and judges that the user is deemed as performing the press function if the user finger stays over 25 ms without passing through adjoining sensor units 220 representing by the dotted arrows. Therefore, the touch input device performs the button-depression function and temporarily stops the click function.

In the present invention, by introducing the metal domes and the rubber cushion sandwiched between the lower and the upper flexible printed circuit boards of the folded flexible printed circuit board of the touch input device, the possible over-deflection upon the touch panel and the flexible printed circuit board causing the press force to focus in one point can be successfully avoided, and the flexibility of the touch input device can be enhanced. The applicability of the touch input device can then be enhanced by increasing the number of the touchable function keys.

Although the present invention and its advantages have been described in detail, as well as some variations over the disclosed embodiments, it should be understood that various other switches, substitutions and alterations can be made herein without departing from the spirit and scope of the invention as defined by the appended claims.

What is claimed is:

1. A touch input device applied to an electronic apparatus comprising:
a touch panel providing an input interface for users;
a flexible printed circuit board, disposed under said touch panel, folded into a C-shape form to divide said flexible printed circuit board into an upper flexible printed circuit board and a lower flexible printed circuit board;
a rubber cushion, disposed between said upper flexible printed circuit board and said lower flexible printed circuit board; and
a plurality of metal domes, disposed between said rubber cushion and said lower flexible printed circuit board, wherein a position of each of said metal domes represents a position of a function key.

2. The touch input device according to claim 1, further comprising a plurality of sensor units, disposed on said upper flexible printed circuit board, which detect a user position so as to move a cursor shown in a screen of said electronic apparatus.

3. The touch input device according to claim 1, wherein said metal domes contact with said rubber cushion and said lower flexible printed circuit board directly.

4. The touch input device according to claim 1, wherein said metal domes contact said rubber cushion directly but are spaced from said lower flexible printed circuit board by a predetermined spacing.

5. The touch input device according to claim 1, wherein said electronic apparatus is a mobile phone, a personal digital assistant, an MP3 player or an input device of a notebook computer.

6. A touch input device, applied to an electronic apparatus, comprising a touch panel, a flexible printed circuit board disposed under said touch panel, a rubber cushion and a plurality of metal domes wherein a position of each of said metal domes represents a position of a function key,
characterized in that: said flexible printed circuit board is folded into a C-shape form to present an upper flexible printed circuit board and a lower flexible printed circuit board, said upper flexible printed circuit board has a plurality of sensor units close to said touch panel so as to detect a user position, said rubber cushion is disposed between said upper flexible printed circuit board and said lower flexible printed circuit board, and said metal domes are disposed between said rubber cushion and said lower flexible printed circuit board.

7. The touch input device according to claim 6, wherein said electronic apparatus is a mobile phone, a personal digital assistant, an MP3 player or an input device of a notebook computer.

8. The touch input device according to claim 6, wherein said metal domes contact said rubber cushion directly.

9. The touch input device according to claim 6, wherein said metal domes are spaced from said lower flexible printed circuit board by a predetermined spacing.
